(19) United States
(12) Patent Application Publication
(10) Pub. No.: US 2014/0224117 A1
(43) Pub. Date: Aug. 14, 2014

(54) INTEGRATED ENGINE AND HYDRAULIC PUMP

(71) Applicant: BRIGGS & STRATTON CORPORATION, Wauwatosa, WI (US)

(72) Inventor: Jason J. Raasch, Cedarburg, WI (US)

(73) Assignee: Briggs & Stratton Corporation, Wauwatosa, WI (US)

(21) Appl. No.: 13/765,299

(22) Filed: Feb. 12, 2013

(51) Int. Cl. F16J 1/00

(52) U.S. Cl. CPC F16J 1/00
USPC 92/172

(57) ABSTRACT

An engine includes a piston located in a piston bore within a cylinder block, a first spring biasing the piston in a first direction, and a second spring biasing the piston in a second direction opposite the first direction, wherein the first spring and the second spring control a displacement of the piston.

### BACKGROUND

The present invention relates generally to the field of engines. More specifically, the invention relates to an engine that is integrated with a hydraulic pump and a pressure washer having an integrated engine and hydraulic pump.

To provide pressurized water, some current pressure washers use internal combustion engines coupled to axial piston pumps. Energy typically flows from an internal combustion engine to the chamber of a water pump piston in the following order: combustion occurs in the engine, creating pressure through expansion of heated gases; the pressure is converted to linear motion via a piston; linear motion is converted to rotary motion via a connecting rod and crankshaft; rotary motion is converted back to linear motion via a wobble plate; and linear motion is converted to a pressure via water pump pistons. Energy losses occur in each of these steps. Furthermore, the large number of components may cause these engines, as well as the pressure washers into which they are incorporated, to be expensive, complex, and heavy.

### SUMMARY

One embodiment of the invention relates to an engine including a piston located in a piston bore within a cylinder block, a first spring biasing the piston in a first direction, and a second spring biasing the piston in a second direction opposite the first direction, wherein the first spring and the second spring control a displacement of the piston.

Another embodiment of the invention relates to an engine including a piston assembly including an engine piston and a hydraulic pump piston rigidly connected to the engine piston, wherein the hydraulic pump piston is located within a hydraulic pump chamber, a force converter configured to absorb a first force applied to the piston assembly and to apply a second force to the piston assembly in a direction opposite to the first force, and a pressurized fluid outlet from the hydraulic pump chamber, wherein reciprocation of the piston assembly causes fluid to exit the hydraulic pump chamber through the pressurized fluid outlet.

Another embodiment of the invention relates to a pressure washer including an engine including a piston assembly including an engine piston and a hydraulic pump piston rigidly connected to the engine piston, wherein the hydraulic pump piston is located within a hydraulic pump chamber, a water inlet fluidly connected to a hydraulic pump chamber, a pressurized water outlet from the hydraulic pump chamber, and a spray gun fluidly coupled to the pressurized water outlet, wherein reciprocation of the piston assembly causes fluid to flow from the hydraulic pump chamber through the pressurized fluid outlet to the spray gun.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1A is a perspective view of a pressure washer system according to an exemplary embodiment of the invention.

FIG. 1B is a perspective view of a pressure washer system according to another exemplary embodiment of the invention.

FIG. 2 is a sectional view of an engine according to a first exemplary embodiment of the invention.

FIG. 3 is a sectional view of an engine according to a second exemplary embodiment of the invention.

FIG. 4A is a sectional view of a portion of an engine in a third exemplary embodiment of the invention, with the piston shown in a bottom dead center position.

FIG. 4B is a sectional view of a portion of an engine in the third exemplary embodiment of the invention, with the piston shown in an intermediate position.

FIG. 4C is a sectional view of a portion of an engine in the third exemplary embodiment of the invention, with the piston shown in a top dead center position.

FIG. 5 is an exemplary graph illustrating free-piston engine pump displacement as a function of time.

FIG. 6 is another exemplary graph illustrating free-piston engine pump displacement as a function of time.

FIG. 7 is a schematic fluid circuit diagram of a pressure washer according to another exemplary embodiment of the invention.

### DETAILED DESCRIPTION

Certain embodiments of the invention reduce cost by eliminating components from the engines typically used in pressure washers. The disclosed engines are intended to increase the efficiency of energy transfer, which improves engine performance. Furthermore, the disclosed engines are intended to have a reduced weight compared to conventional engines. In turn, the pressure washers or other machines into which the engines are incorporated are intended to be lighter and more manageable. It should be understood that the engine embodiments disclosed herein may be used in any type of equipment requiring an engine, and in particular in any type of equipment requiring both an engine and a pump. Although it is preferable for the engines to be integrated with a liquid pump, engines integrated with other types of pumps fall within the scope of this application.

Before turning to the figures, which illustrate the exemplary embodiments in detail, it should be understood that the present application is not limited to the details set forth in the description or illustrated in the figures. It should also be understood that the terminology is for purpose of description only and should not be regarded as limiting.

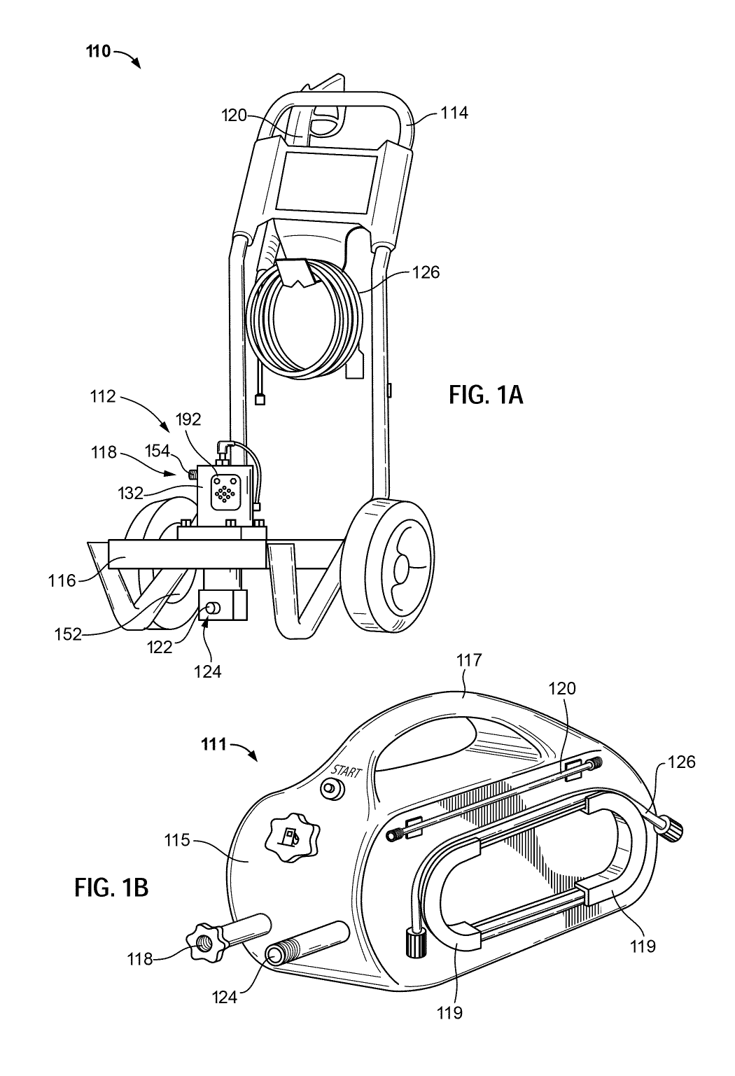

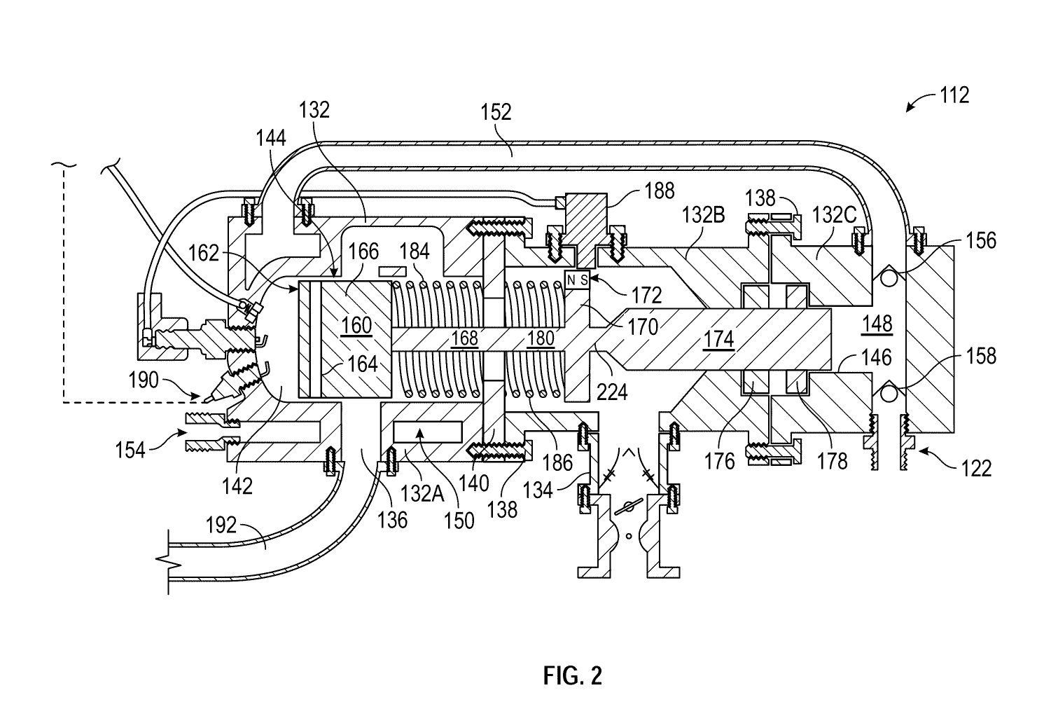

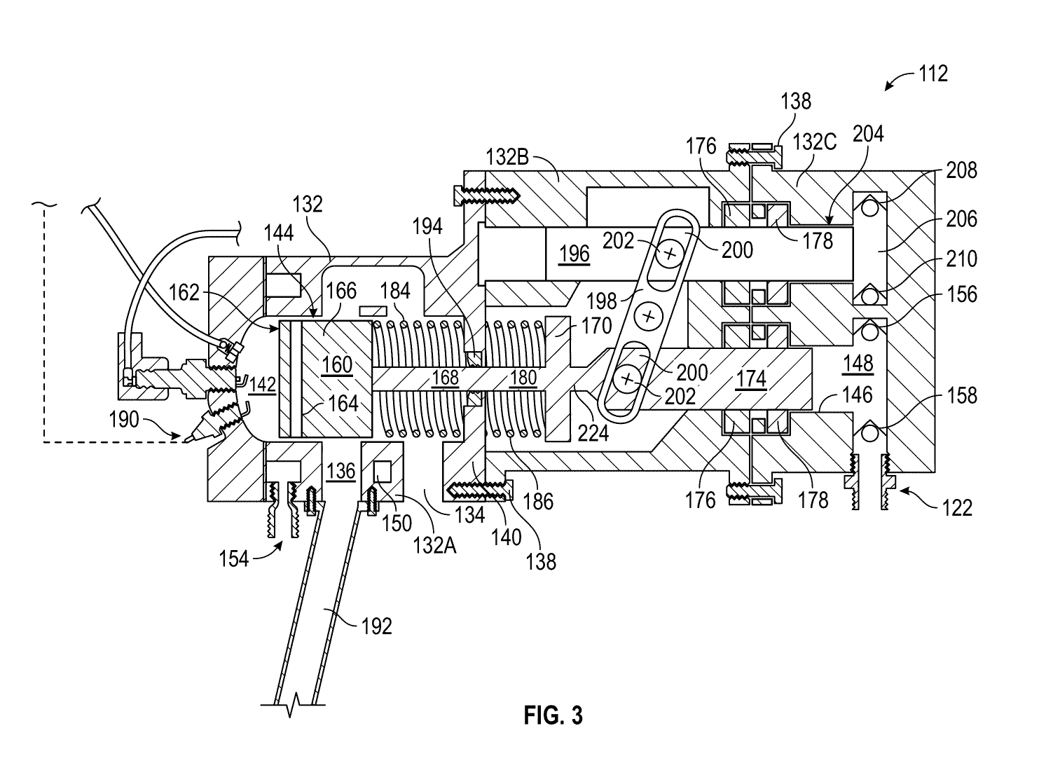

FIG. 1A is a perspective view of a pressure washer 110 that includes an engine 112. The engine 112 is supported by a frame 114, which includes a base plate 116 to which the engine 112 is fastened. The engine 112 may comprise any of the engine embodiments described below in conjunction with the remaining Figures, although the engine 112 is preferably an integrated engine and hydraulic pump. The pressure washer 110 further includes a water inlet 118, which may be connected to a garden hose or other water source. The water inlet 118 of the pressure washer is fluidly connected to, and may be formed integrally with, a fluid inlet 154 located on the engine 112 (shown in FIGS. 2 and 3), which in turn is fluidly connected to a hydraulic pump chamber 148 of the engine 112. Water exits the hydraulic pump chamber 148 of the engine 112 through a pressurized fluid outlet 122. The pressurized fluid outlet 122 of the engine 112 is fluidly connected to, and may be formed integrally with, a pressurized water outlet 124 located on the pressure washer 110. The pressurized water outlet 124 may be fluidly connected to an external water sprayer 120, although the external water sprayer 120 is shown in a disconnected state in FIG. 1A. A high pressure hose 126 may be connected to the pressurized water outlet 124 for receiving the pressurized water and delivering the water to the external water sprayer 120.

FIG. 1B is a perspective view of a pressure washer 111 that includes a water-cooled engine in a compact, handheld housing 115 (e.g., enclosure, casing, etc.), which may include a handle 117 to facilitate the transportation of the pressure washer 111. The engine may comprise any of the engine embodiments described below in conjunction with the remaining Figures, although the engine preferably is an integrated engine and hydraulic pump. The pressure washer 111 further includes a water inlet 118, which may be connected to a garden hose or other water source. Water exits the pressure washer 111 through a pressurized water outlet 124. The pressurized water outlet 124 may be fluidly connected to an external water sprayer 120, although the external water sprayer 120 is shown in a disconnected state in FIG. 1B. A high pressure hose 126 may be connected to the pressurized water outlet 124 for receiving the pressurized water and delivering the water to the external water sprayer 120. Projections 119 support the high pressure hose 126 in a storage position.

FIG. 2 is a cross-sectional view of an engine 112 according to a first exemplary embodiment of the invention. In this embodiment, the engine operates as a two-stroke engine, although other contemplated embodiments may utilize an alternative number of strokes. The engine 112 is shown as an internal combustion engine, but the invention also contemplates other types of engines.

In the two-stroke engine 112 shown in FIG. 2, the cylinder block 132 includes an inlet valve 134 (e.g. Reed valve) and an exhaust port 136 to allow for fuel intake and exhaust release, respectively. The cylinder block 132 may be formed by the connection of any number of structural components 132A, 132B and 132C, fastened together with screws 138 or other fastening elements. The cylinder block 132 may also include a divider 140 extending into an interior portion of the block. The divider 140 may be formed integrally with the cylinder block 132 or it may comprise a separate portion rigidly connected to the cylinder block 132 by screws 138 or other fastening elements. The interior portion of the cylinder block 132 includes a combustion chamber 142, an engine piston bore 144, a hydraulic pump piston bore 146, and a hydraulic pump chamber 148.

Fluid or water enters the engine 112 and cylinder block 132 through a fluid inlet 154. The fluid may flow through a water jacket 150 in order to facilitate cooling of the engine 112. The water jacket 150 is formed within the cylinder block 132, particularly in the region of the engine piston bore 144. Water within the water jacket 150 cools the engine by absorbing heat created by combustion within the combustion chamber 142. The water jacket 150 can be formed in a variety of configurations within the cylinder block 132 and/or engine housing to most effectively cool the engine 112. A pipe 152 connects portions of the water jacket 150 and fluidly connects the fluid inlet 154 to the hydraulic pump chamber 148. Other structures may also be employed to route fluid from the fluid inlet 154 to the hydraulic pump chamber 148. For example, a pathway can be formed within the cylinder block 132.

Fluid enters the hydraulic pump chamber 148 through first check valve 156. Once within the hydraulic pump chamber 148, fluid exits through second check valve 158. Other suitable types of valves and mechanisms may also be employed to control the flow of fluid into and out of the hydraulic pump chamber 148. Fluid flowing out of the second check valve 158 is pressurized due to the reciprocation of the piston assembly 180 (described below), and flows out of the engine through a pressurized fluid outlet 122. The pressurized fluid may then be routed to an external water sprayer 120 of a pressure washer (see FIG. 1) or other device external to the engine 112.

An engine piston 160 is located within the engine piston bore 144. The engine piston 160 may comprise an engine piston head 162, ring grooves 164, and a skirt 166. The engine piston 160 reciprocates within the engine piston bore 144 from a top dead center position to a bottom dead center position.

In an exemplary embodiment, a rod 168 connects the engine piston 160 to a base 170. The rod 168 may be of any shape and size, and can be made of any material suitable for withstanding the forces exerted onto the engine piston 160. The base 170 comprises a magnet 172, which will be discussed below in conjunction with the ignition system.

A hydraulic pump piston 174 is connected to the base 170. FIGS. 2 and 3 illustrate an essentially cylindrical hydraulic pump piston 174, but the hydraulic pump piston 174 may be any shape that allows it to effectively pump fluid. The drawings depict a small rod portion 224 connecting the base 170 to the hydraulic pump piston 174. However, the base 170 may be directly connected to the hydraulic pump piston 174. Alternatively, the edge of the hydraulic pump piston 174 may serve the functions of a base 170, rendering a separate base unnecessary. The hydraulic pump piston 174 reciprocates within the hydraulic pump piston bore 146. To prevent leakage of oil and fluid during reciprocation of the hydraulic pump piston 174, the inner surface of the hydraulic pump piston bore 146 includes a hydraulic pump oil seal 176 and a hydraulic pump fluid seal 178 surrounding the hydraulic pump piston 174.

In some embodiments, the engine piston 160 and hydraulic pump piston 174 are rigidly connected to form an integrated piston assembly 180 that reciprocates within the cylinder block 132. In some embodiments, the engine piston 160 and the hydraulic pump piston 174 are axially aligned with each other (i.e., the longitudinal axis of the engine piston 160 and the longitudinal axis of the hydraulic pump piston 174 are collinear so that the engine piston 160 and the hydraulic pump piston 174 reciprocate along the same axis). In an exemplary embodiment, the piston assembly 180 reciprocates without the aid of a crankshaft. Thus, the engine 112 is a free-piston engine. In general terms, “free-piston” indicates that the motion of a piston is not restricted by the motion of a rotating crankshaft, which converts linear (reciprocating) motion of a piston into rotary motion. The engine 112 therefore does not convert the linear motion of the engine piston 160 to rotary motion. Instead, the engine piston 160 and the hydraulic pump piston 174 reciprocate as a unit within the cylinder block 132. The engine 112 comprising an integrated engine piston 160 and hydraulic pump piston 174 is referred to as a free-piston engine pump (FPEP).

A force converter, shown as, but not limited to, a spring 184 is provided to control displacement and reciprocation of the piston assembly 180. The force converter may be any structural mechanism capable of absorbing, storing, and applying forces to a component of the piston assembly 180. In the illustrated embodiment, the force converter comprises at least one spring 184. The spring 184 is disposed between the engine piston 160 and the divider 140. However, the spring 184 may be positioned in any location that will allow it to control displacement of the piston assembly 180. For example, one end of the spring 184 could be connected to the circumference of the engine piston bore 144 or to another surface of the cylinder block 132 instead of to the divider 140. Furthermore, the spring 184 may be disposed entirely on one side of the rod 168, instead of wrapping around the rod 168. In some embodiments, the spring 184 may not be fixed to one or both of the engine piston 160 and the divider 140, but rather only abut the surface of the adjacent structure. Spring 184 may further comprise multiple spring elements.

The spring 184 controls displacement of the assembly by absorbing a force applied to the engine piston 160 by, for example, the ignition of an air-fuel mixture within the combustion chamber 142. During the combustion stroke, the ignition of the air-fuel mixture in the combustion chamber 142 urges the engine piston 160 towards a bottom dead center position (to the right in FIGS. 2 and 3). The spring 184 compresses in response, storing the transmitted energy and applying a force to the engine piston 160 in a direction that urges the engine piston 160 towards a top dead center position (to the left in FIGS. 2 and 3). Thus, the spring 184 acts on the engine piston 160 in a direction that opposes the combustion forces acting on the piston head 162.

In some embodiments, the force converter further comprises a second spring 186. The second spring 186 is disposed between the divider 140 and the base 170. As the spring 184 (referred to hereinafter as the “first” spring 184) is compressed during the combustion stroke of the piston assembly 180, the second spring 186 expands. In contrast, when the first spring 184 expands during the compression stroke of the piston assembly 180, the second spring 186 is compressed. As described above in relation to the first spring 184, the second spring 186 may also be located in any suitable location, may be fixed or unfixed to its adjacent structures, and may comprise multiple spring elements.

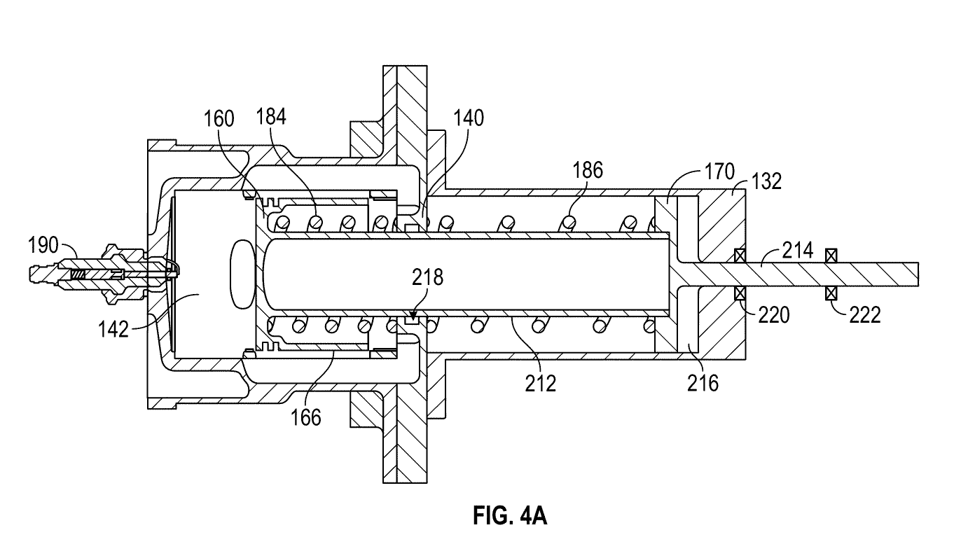

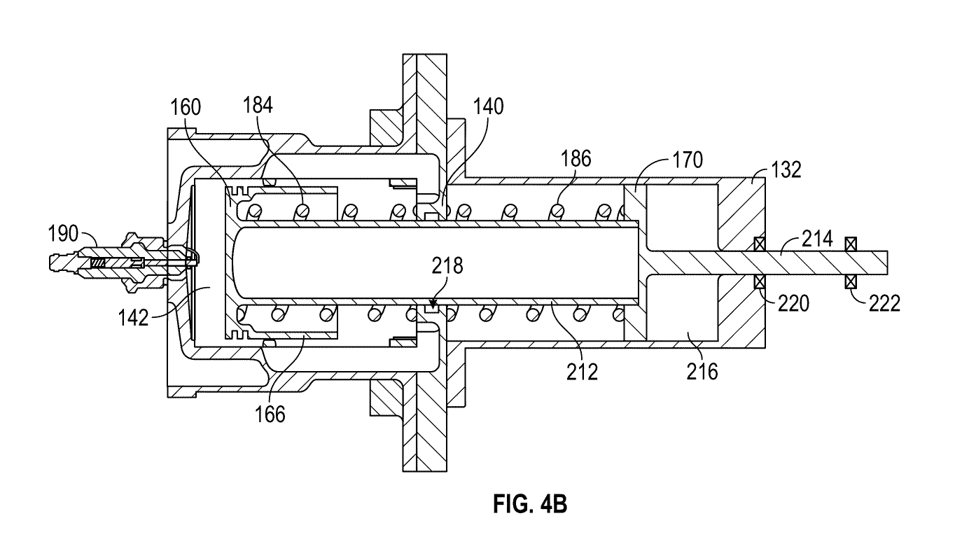

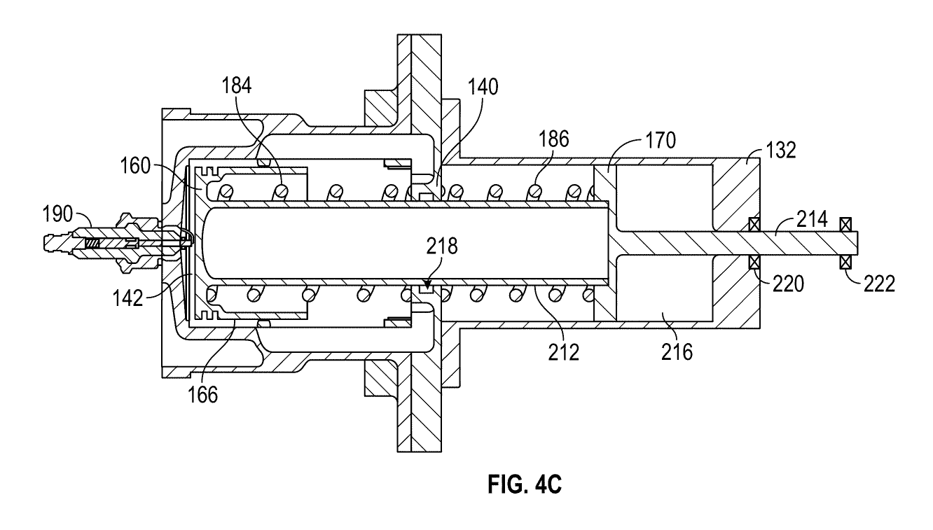

The properties (e.g. material, fatigue strength, size, etc.) of the two springs 184, 186 are selected to effectively control displacement of the piston assembly 180 during operation of the engine 112. The selection of the two springs 184, 186 should take into consideration various additional factors related to the engine 112, including, for example, the sizes of the engine piston 160 and hydraulic pump piston 174, the forces exerted by combustion within the combustion chamber 142, and the pressure of fluid within the hydraulic pump chamber 148. When the engine 112 is turned off, the piston assembly 180 should remain in an intermediate position. That is, the forces exerted by the springs 184, 186 should hold the piston assembly 180 in a position that is between top dead center and bottom dead center (see FIG. 4B).

An ignition system for the engine 112 may include an ignition coil 188 and one or more spark plugs 190. A magnet 172 located on the base 170 generates timed sparks from the spark plugs 190, which extend through a cylinder head into the combustion chamber 142. The magnet 172 may be located on any component of the piston assembly 180. Furthermore, any suitable type of ignition system may be employed to ignite fuel in the combustion chamber 142. Wiring and tubing connect the spark plug 190 and the combustion chamber 142 to a primer source and additional components of the ignition system.

FIG. 3 illustrates a sectional view of an engine 112 according to a second exemplary embodiment of the invention. It should be understood that the engine 112 of FIG. 3 may include any of the elements shown in FIG. 2. Furthermore, elements common to each drawing will not be described again below.

In the embodiment of FIG. 3, the inlet valve 134 is located in an alternative location on the interior portion of the cylinder block 132. Specifically, the inlet valve 134 is located on the opposite side of the divider 140 than the inlet valve 134 shown in FIG. 2. The exhaust port 136 of the engine 112 may similarly be located in alternative locations. As illustrated in FIGS. 2 and 3, the exhaust pipe 192 may comprise varying structural configurations (e.g. straight, curved, etc.). The fluid inlet 154 of the engine 112 can be located and positioned in any configuration that allows successful alignment and/or integration with the water inlet 118 of the pressure washer 110 (see FIG. 1) so that a water source may be connected to the pressure washer 110 and engine 112. FIG. 3 further illustrates the placement of a seal 194 along the inner surface of the divider 140 and surrounding the rod 168.

The engine 112 shown in FIG. 3 includes a second piston 196 mechanically linked to the piston assembly 180 by a connecting structure 198. The connecting structure 198 comprises a flattened, elongated bar having two slots 200, although other shapes and types of connecting structures are contemplated. Protrusions 202 extending from the piston assembly 180 and the second piston 196 fit into the slots 200, holding the connecting structure to the piston assembly 180 and the second piston 196. However, other fastening elements that allow for pivotal movement may be used in place of the protrusions 202 and the slots 200.

The second piston 196 is located in a second piston bore 204 and is configured to reciprocate within the second piston bore 204 in connection with reciprocation of piston assembly 180. The second piston bore 204 includes a hydraulic pump oil seal 176 and a hydraulic pump fluid seal 178 to prevent leakage of oil and fluid, respectively. The second piston 196 helps control the movement of piston assembly 180 by vibration cancellation. The hydraulic pump chamber 206 of the second piston 196 includes check valves 208 and 210. The check valves may fluidly connect the hydraulic pump chamber 206 of the second piston 196 to a water jacket system (not shown in FIG. 3) or other fluid source, to the hydraulic pump chamber 148 of the piston assembly 180, or to a pressurized fluid manifold.

FIGS. 4A-4C illustrate sectional views of a portion of an engine 112 in a third exemplary embodiment of the invention. The piston 160 is connected to a first rod portion 212, which is in turn connected to a base 170. A second rod portion 214 extends from the base 170 and protrudes from an interior portion 216 of the cylinder block 132. FIG. 4A shows the piston 160 in a bottom dead center position, FIG. 4B shows the piston 160 in an intermediate position, and FIG. 4C shows the piston 160 in a top dead center position. A spark plug 190 extends into the combustion chamber 142. A first spring 184 is located underneath the piston skirt 166 and is disposed between the piston 160 and the divider 140 extending into the interior of the cylinder block 132. A second spring 186 is disposed between the divider 140 and the base 170. The inner surface of the divider 140 includes a seal 218 surrounding the first rod portion 212. In addition, seals 220 and 222 may surround the second rod portion 214.

To begin reciprocation of a piston assembly 180 in any of the embodiments described above, the engine 112 may include an additional structure geared towards initiating motion. For example, a hand pump may be linked to the hydraulic pump chamber 148, 206 of the hydraulic pump piston 174 or the second piston 196. A user operates the hand pump to apply pressure to the hydraulic pump chamber 148 or 206 and initiate movement of the piston assembly 180 and/or the second piston 196. Alternatively, a pump may be provided to pump air into the combustion chamber 142. Fuel can then be injected into the combustion chamber 142 and ignited, exerting a force onto the engine piston head 162.

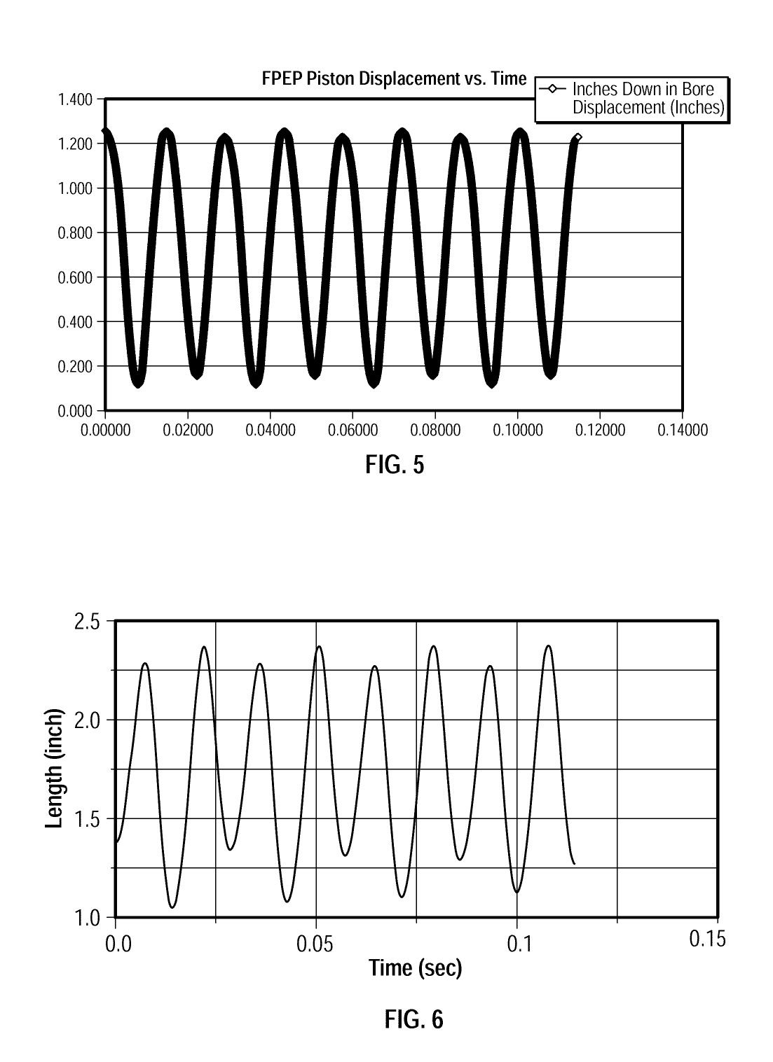

FIG. 5 is an exemplary graph of FPEP displacement as a function of time. Time is shown on the X-axis, and inches down in bore displacement is shown on the Y-axis. As can be seen from the graph, the engine piston (and correspondingly, the piston assembly) reciprocates within an engine piston bore, in this embodiment, with a stroke of approximately 1.15 inches. However, the stroke of the engine piston can be altered to any length by changing other parameters of the engine, including but not limited to the dimensions of the engine piston bore, the properties of the springs or other force converters, and the characteristics of the ignition system.

FIG. 6 is another exemplary graph illustrating FPEP displacement as a function of time. In this embodiment, the piston stroke is approximately 1 inch, although the stroke length varies slightly between combustion and compression strokes. As described above in reference to FIG. 5, the piston stroke may be altered by varying other parameters of the engine.

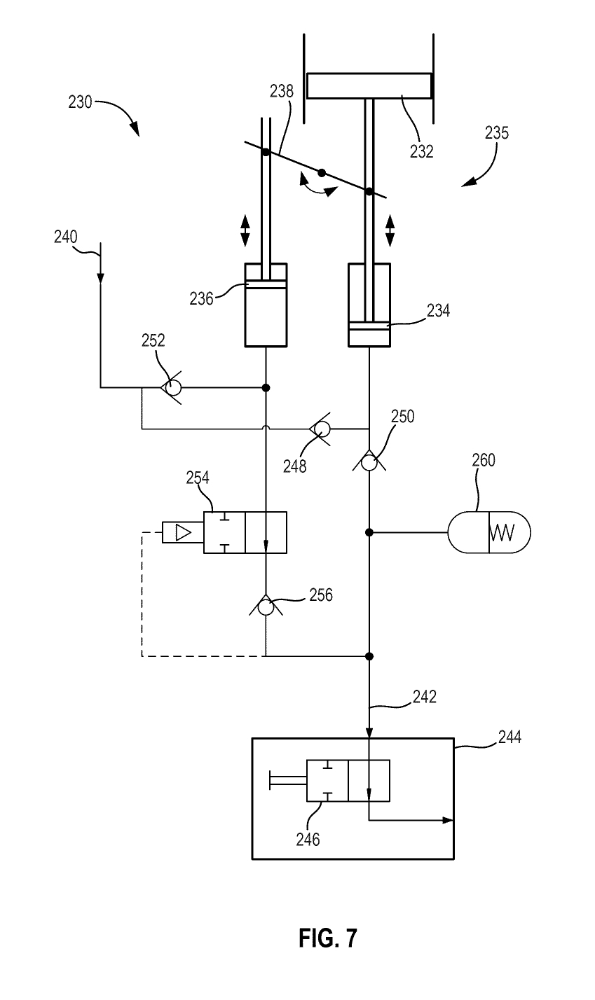

FIG. 7 illustrates a schematic view of a hydraulic circuit of a pressure washer engine 230 according to another exemplary embodiment. The pressure washer engine 230 includes a starting and stopping capability. The engine 230 may be similar to the engine 112 as shown in FIG. 3 and include an engine piston 232 that reciprocates within an engine piston bore from a top dead center position to a bottom dead center position. A first hydraulic pump piston 234 is rigidly connected with the engine piston 232 to form an integrated piston assembly 235. In some embodiments, the first hydraulic pump piston 234 and the engine piston are axially aligned with each other. A second hydraulic piston 236 is mechanically linked to the piston assembly 235 by a connecting structure 238 and is configured to reciprocate in connection with reciprocation of piston assembly 235. The first hydraulic pump piston 234 and the second hydraulic pump piston 236 reciprocate opposite from one another (i.e., when the first hydraulic pump piston 234 is at the top dead center position, the second hydraulic pump piston 236 is at the bottom dead center position and vice versa). Fluid enters the hydraulic circuit through an inlet 240 and fluid is expelled from an outlet 242. In one exemplary embodiment, the outlet 242 may be coupled to a device such as a spray gun 244 with a trigger or other feature (e.g., a push-button, a toggle switch, a pressure sensitive switch, a foot-activated switch, etc.) that is configured to allow a user to start or stop the flow of pressurized fluid by opening or closing a valve 246. The valve 246 may be configured to be normally closed (e.g., the valve 246 may be opened only when a user pulls a spring-loaded trigger or depresses a button). The fluid circuit further includes an accumulator 260 (e.g., a spring-loaded accumulator) provided between the hydraulic piston 234 and the outlet 242.

Fluid enters the hydraulic pump chamber of the first hydraulic piston 234 through a first check valve 248 and exits through a second check valve 250. Fluid enters the hydraulic pump chamber of the second hydraulic piston 236 through a third check valve 252 and exits through a control valve 254 and a fourth check valve 256. The control valve 254 opens and closes in response to the back pressure upstream of the valve 246 in the spray gun 244. At a first relatively high back pressure with the valve 246 closed, the control valve 254 closes. At a second relatively low back pressure with the valve 246 open, the control valve 254 opens. If the valve 246 in the spray gun 244 is open, the fluid passes through the spray gun 244 and is output through the spray gun nozzle. If the valve 246 is closed, the back pressure upstream from the valve 246 increases, closing the control valve 254. With the control valve 254 closed, the outlet passage from the hydraulic pump chamber of the second hydraulic piston 236 is closed. The outlet passage from the hydraulic pump chamber of the first hydraulic piston 234 remains open and fluid is received in the accumulator 260. The second hydraulic piston 236 is stopped in a retracted position (top dead center) while the first hydraulic piston 234 is stopped in an extended position (bottom dead center) (as shown in FIG. 7), which stops the engine piston 232 in the bottom dead center position and stalls the engine 230. In the bottom dead center position, the engine piston 232 stores potential energy in a force converter, such as by depressing a spring (e.g., spring 184 as shown in FIG. 4A). Once the valve 246 is opened and the spray gun 244 is activated, control valve 254 opens in response to the decrease in back pressure upstream of the valve 246 and the engine piston 232 and the hydraulic pistons 234 and 236 are allowed to reciprocate. The potential energy stored in the force converter (e.g., spring 184) biases the engine piston 232 back toward the top dead position, restarting the engine 230 and resuming the pumping of water by the engine 230.

The construction and arrangement of the engines and pressure washer, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention.

What is claimed is:

1. An engine, comprising:
a piston located in a piston bore within a cylinder block;
a first spring biasing the piston in a first direction; and
a second spring biasing the piston in a second direction opposite the first direction;
wherein the first spring and the second spring control a displacement of the piston.

2. The engine of claim 1, further comprising a hydraulic pump piston connected to the piston and located within a hydraulic pump chamber.

3. The engine of claim 2, further comprising a water jacket configured to cool the engine.

4. The engine of claim 2, further comprising:
a second piston mechanically linked to at least one of the piston and the hydraulic pump piston.

5. The engine of claim 2, wherein the piston and the hydraulic pump piston are axially aligned with each other.

6. The engine of claim 5, further comprising:
a spark plug; and
a magnet coupled to the piston and configured to trigger ignition of the spark plug.

7. An engine, comprising:
a piston assembly comprising an engine piston and a hydraulic pump piston rigidly connected to the engine piston, wherein the hydraulic pump piston is located within a hydraulic pump chamber;
a force converter configured to absorb a first force applied to the piston assembly and to apply a second force to the piston assembly in a direction opposite to the first force; and
a pressurized fluid outlet from the hydraulic pump chamber;
wherein reciprocation of the piston assembly causes fluid to exit the hydraulic pump chamber through the pressurized fluid outlet.

8. The engine of claim 7, wherein the engine piston and the hydraulic pump piston are axially aligned with each other.

9. The engine of claim 7, further comprising:
a spark plug; and
a magnet coupled to the piston assembly and configured to trigger ignition of the spark plug.

10. The engine of claim 7, further comprising a water jacket configured to cool the engine.

11. The engine of claim 7, wherein the force converter comprises a spring.

12. The engine of claim 11, wherein the spring is disposed between the engine piston and an interior surface of a cylinder block.

13. The engine of claim 7, wherein the force converter comprises at least two springs.

14. A pressure washer, comprising:
an engine including a piston assembly comprising an engine piston and a hydraulic pump piston rigidly connected to the engine piston, wherein the hydraulic pump piston is located within a hydraulic pump chamber;
a water inlet fluidly connected to a hydraulic pump chamber;
a pressurized water outlet from the hydraulic pump chamber; and
a spray gun fluidly coupled to the pressurized water outlet;
wherein reciprocation of the piston assembly causes fluid to flow from the hydraulic pump chamber through the pressurized fluid outlet to the spray gun.

15. The pressure washer of claim 14, further comprising a force converter disposed within the cylinder block and configured to absorb force from and apply force to the piston assembly.

16. The pressure washer of claim 15, wherein the force converter comprises a spring.

17. The pressure washer of claim 15, further comprising:
a second piston mechanically linked to the piston assembly so that the second piston reciprocates opposite the hydraulic pump piston;
a control valve that opens and closes in response to a back pressure from the spray gun;
wherein at a first back pressure, the second piston stops at top dead center, the hydraulic pump piston stops at bottom dead center, and the engine piston stops at bottom dead center, thereby stalling the engine and storing force in the force converter; and
wherein at a second back pressure less than the first back pressure, the force converter applies the stored force to the engine piston, thereby starting the engine.

18. The pressure washer of claim 17, wherein the spray gun includes a valve movable to a closed position resulting in the first back pressure and to an open position resulting in the second back pressure.

19. The pressure washer of claim 14, further comprising:
a spark plug; and
a magnet coupled to the piston assembly and configured to trigger ignition of the spark plug.

20. The pressure washer of claim 14, further comprising a water jacket configured to cool the engine.
